(19) United States
(12) Patent Application Publication
(10) Pub. No.: US 2026/0278996 A1
(43) Pub. Date: Sep. 17, 2026

(54) IMAGE PROCESSING APPARATUS AND IMAGE PROCESSING METHOD

(71) Applicant: Kioxia Corporation, Tokyo (JP)

(72) Inventors: Yumi Mori, Yokohama Kanagawa (JP); Miyuki Kouda, Yokkaichi Mie (JP); Youyang NG, Kamakura Kanagawa (JP)

(73) Assignee: Kioxia Corporation, Tokyo (JP)

(21) Appl. No.: 19/321,622

(22) Filed: Sep. 8, 2025

(30) Foreign Application Priority Data
Mar. 13, 2025 (JP) 2025-040655

(51) Int. Cl. G06V 10/26; G06V 10/20; G06V 10/74; G06V 10/764; G06V 10/774; G06V 10/82; G06V 20/70

(52) U.S. Cl. CPC G06V 10/273; G06V 10/255; G06V 10/761; G06V 10/764; G06V 10/7747; G06V 10/82; G06V 20/70

(57) ABSTRACT

An image processing apparatus has processing circuitry configured to perform learning of a first model for detecting a length measurement target region included in a learning image, perform learning of a second model for detecting an attention region included in the learning image, input a detection target image to the learned first model and detect a length measurement target region inferred by the first model, input an image of the detected length measurement target region to the learned second model and detect an attention region inferred by the second model, and perform length measurement of the length measurement target region based on the detected attention region.

### CROSS REFERENCE TO RELATED APPLICATIONS

This application is based upon and claims the benefit of priority from the prior Japanese Patent Application No. 2025-040655, filed on Mar. 13, 2025, the entire contents of which are incorporated herein by reference.

### FIELD

The present disclosure relates to an image processing apparatus and an image processing method.

### BACKGROUND

A technique of detecting a specific shape from a detection target image using a learning image including the specific shape and a model that has learned information regarding the specific shape included in the learning image has been proposed.

However, in the existing technique, it is assumed that no noise is included in the detection target image, and in a case where noise is included in the detection target image, detection accuracy of the specific shape may decrease. In addition, in a case where the detection accuracy of a contour boundary of the detection target image is low, it is difficult to detect a detection target region itself.

Furthermore, in the existing technique, a large amount of learning images are required to learn the model, and it takes time and effort to construct the model.

### BRIEF DESCRIPTION OF THE DRAWINGS

FIG. 1 is a block diagram illustrating a schematic configuration of an image processing apparatus according to a first embodiment;

FIG. 2 is a flowchart illustrating a processing operation of the image processing apparatus according to the first embodiment;

FIG. 3 is a diagram illustrating an example of image processing performed by the image processing apparatus according to the first embodiment;

FIG. 4 is a diagram for explaining processing operations of a first learning image generation unit and a second learning image generation unit in FIG. 1 in detail;

FIG. 5 is a diagram for explaining processing operations of a first model learning unit, a second model learning unit, a length measurement target region detection unit, an attention region detection unit, and a length measurement unit in FIG. 1 in detail;

FIG. 6 is a block diagram illustrating a schematic configuration of an image processing apparatus according to a second embodiment;

FIG. 7 is a flowchart illustrating a processing operation of the image processing apparatus according to the second embodiment;

FIG. 8 is a diagram for explaining a processing operation of a learning image generation unit in FIG. 7;

FIG. 9 is a diagram for explaining the processing operation of the learning image generation unit in FIG. 7 in detail;

FIG. 10 is a diagram for explaining a processing operation of a learning image generation unit according to a third embodiment;

FIG. 11 is a diagram for explaining the processing operation of the learning image generation unit according to the third embodiment in detail;

FIG. 12 is a diagram for explaining a processing operation of a learning image generation unit according to a fourth embodiment;

FIG. 13 is a diagram for explaining the processing operation of the learning image generation unit according to the fourth embodiment in detail;

FIG. 14 is a block diagram illustrating a schematic configuration of an image processing apparatus according to a fifth embodiment;

FIG. 15 is a diagram for explaining processing operations of a positional deviation determination unit and a first learning image addition unit according to the fifth embodiment;

FIG. 16 is a diagram in which a position correction unit is added to FIG. 15;

FIG. 17 is a flowchart illustrating a processing operation of the image processing apparatus according to the fifth embodiment;

FIG. 18 is a block diagram illustrating a schematic configuration of an image processing apparatus according to a sixth embodiment;

FIG. 19 is a flowchart illustrating a processing operation of the image processing apparatus according to the sixth embodiment;

FIG. 20 is a diagram for explaining a processing operation of a noise detection unit according to the sixth embodiment;

FIG. 21 is a diagram for explaining processing operations of the noise detection unit and a second learning image generation unit in more detail;

FIG. 22 is a block diagram illustrating a schematic configuration of an image processing apparatus according to a seventh embodiment;

FIG. 23 is a diagram for explaining processing operations of a length measurement value determination unit and a second learning image addition unit according to the seventh embodiment;

FIG. 24 is a diagram for explaining processing operations of the length measurement value determination unit and the second learning image addition unit according to the seventh embodiment in more detail;

FIG. 25 is a flowchart illustrating a processing operation of the image processing apparatus according to the seventh embodiment;

FIG. 26 is a block diagram illustrating a schematic configuration of an image processing apparatus according to an eighth embodiment; and

FIG. 27 is a diagram for explaining a processing operation of a contour detection unit of FIG. 26.

### DETAILED DESCRIPTION

An image processing apparatus according to an embodiment includes processing circuitry configured to:
perform learning of a first model for detecting a length measurement target region included in a learning image;
perform learning of a second model for detecting an attention region included in the learning image;
input a detection target image to the learned first model and detect a length measurement target region inferred by the first model;
input an image of the detected length measurement target region to the learned second model and detect an attention region inferred by the second model; and
perform length measurement of the length measurement target region based on the detected attention region.

Hereinafter, embodiments of an image processing apparatus and an image processing method will be described with reference to the drawings. Although main components of the image processing apparatus will be mainly described below, the image processing apparatus may have components and functions that are not illustrated or described. The following description does not exclude the components and functions that are not illustrated or described.

### First Embodiment

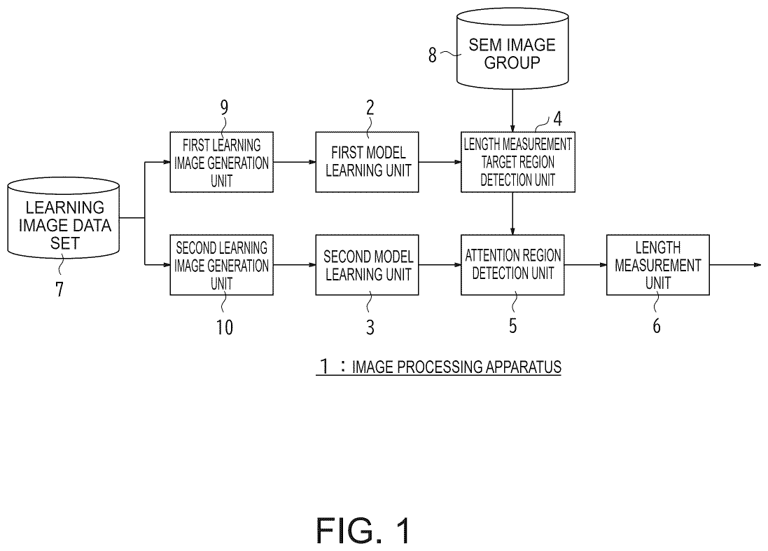

FIG. 1 is a block diagram illustrating a schematic configuration of an image processing apparatus 1 according to a first embodiment. The image processing apparatus 1 illustrated in FIG. 1 includes, for example, a general-purpose computer, a central processing unit (CPU), or the like. As will be described later, at least some functions of the image processing apparatus 1 according to the embodiment can be implemented by hardware or software. In a case where at least some functions of the image processing apparatus 1 are implemented by software, the functions of the image processing apparatus 1 can be implemented by a computer or a CPU executing a program. Hereinafter, the computer or the CPU may be called as processing circuitry.

As illustrated in FIG. 1, the image processing apparatus 1 according to the first embodiment includes a first model learning unit 2, a second model learning unit 3, a length measurement target region detection unit 4, an attention region detection unit 5, and a length measurement unit 6.

The first model learning unit 2 learns a length measurement target region model (first model) for detecting a length measurement target region included in a learning image. The learning image is read out from a learning image storage unit 7, for example. The learning image storage unit 7 stores a learning image data set including a plurality of learning images. The learning image is, for example, a semiconductor image. The semiconductor image may be a cross-sectional image of a semiconductor device, or may be a layout image or an external appearance image. In addition, the learning image is not necessarily a semiconductor image, and any image such as a microscopic image can be applied. In the present specification, an example in which the learning image is a semiconductor image will be mainly described. The length measurement target region refers to a region having a characteristic shape of the learning image. The characteristic shape refers to a contour of the learning image, shapes of various parts included in the learning image, or the like. The length measurement target region model is a model that detects a length measurement target region included in the input learning image by inference processing by machine learning. The first model learning unit 2 performs learning of the length measurement target region model by using the plurality of learning images.

The second model learning unit 3 learns an attention region model (second model) for detecting an attention region included in the learning image. The attention region includes at least one of a contour of the length measurement target area, a shape of the length measurement target area, or various parts included in the length measurement target area.

The types of the length measurement target region model and the attention region model are not limited. For example, a semantic segmentation model such as U-Net may be used. In addition, a type of a loss function used to determine an end condition of learning of the length measurement target region model and the attention region model is also arbitrary. For example, DiceLoss may be used as the loss function.

The length measurement target region detection unit 4 inputs a detection target image to the learned length measurement target region model (first model), and detects a length measurement target region inferred by the length measurement target region model. The detection target image is an image to be subjected to length measurement. Although the type of the detection target image is not limited, an example in which the detection target image is a semiconductor image will be mainly described in the present specification. For example, the length measurement target region detection unit 4 selects an arbitrary detection target image from a SEM image group including a plurality of detection target images. The SEM image group is stored in, for example, a detection target image storage unit 8. For example, the length measurement unit 6 measures a dimension of a characteristic shape of the length measurement target area.

The attention region detection unit 5 inputs an image of the length measurement target region (hereinafter, a length measurement target region image) detected by the length measurement target region detection unit 4 to the learned attention region model (second model), and detects an attention region inferred by the attention region model.

The length measurement unit 6 performs length measurement of critical dimension (CD) of the length measurement target region based on the attention region detected by the attention region detection unit 5. For example, the length measurement unit 6 measures a dimension of the attention region included in the length measurement target area. The length measurement unit 6 does not necessarily measure one length. The length measurement unit 6 may perform length measurement of each of a plurality of characteristic shapes of the length measurement target area.

The image processing apparatus 1 according to the first embodiment may include a first learning image generation unit 9 and a second learning image generation unit 10.

The first learning image generation unit 9 generates a length measurement target region learning image to be used by the first model learning unit 2 for learning the length measurement target region model based on the learning image. The first model learning unit 2 performs learning of the length measurement target region model for detecting the length measurement target region included in the length measurement target region learning image.

The second learning image generation unit 10 generates an attention region learning image to be used by the second model learning unit 3 for learning the attention region model based on the learning image. The second model learning unit 3 performs learning of the attention region model for detecting the attention region included in the attention region learning image.

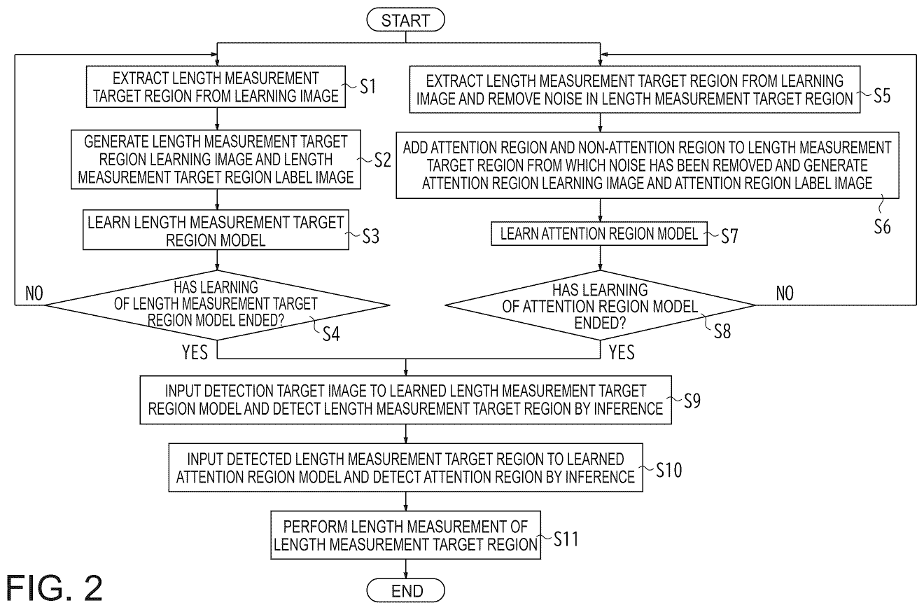

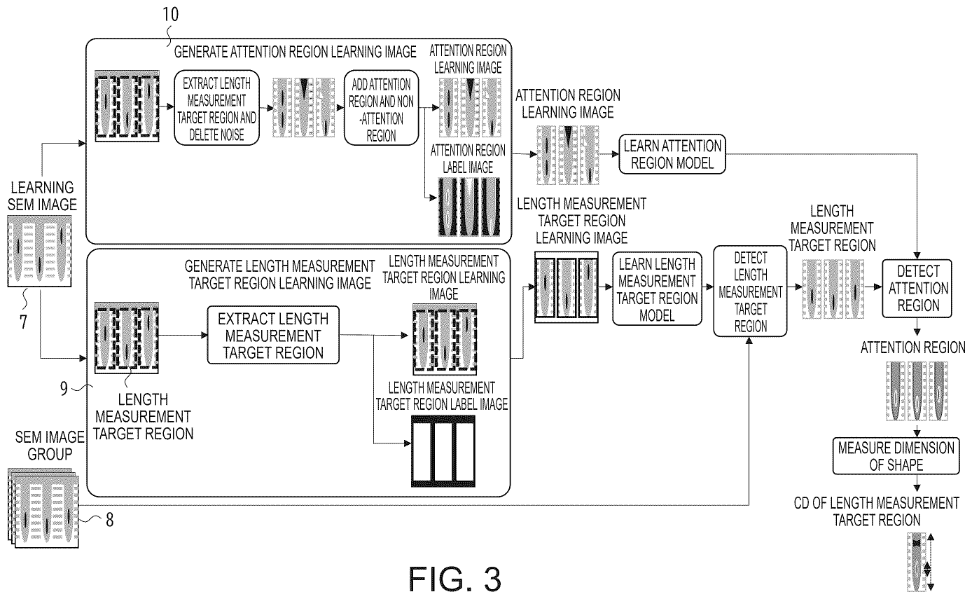

FIG. 2 is a flowchart illustrating a processing operation of the image processing apparatus 1 according to the first embodiment, and FIG. 3 is a diagram illustrating an example of image processing performed by the image processing apparatus 1 according to the first embodiment. FIG. 3 illustrates an example in which the learning image and the detection target image are SEM images of the semiconductor device.

As illustrated in FIG. 2, the first learning image generation unit 9 extracts a length measurement target region from a learning image (step S1). In FIG. 3, the length measurement target region is indicated by a broken line.

Next, the first learning image generation unit 9 generates a length measurement target region learning image and a length measurement target region label image (first label image) based on the extracted length measurement target region (step S2). The length measurement target region label image is information for specifying a location of the length measurement target area. In FIG. 3, the length measurement target region is illustrated in white.

Next, the first model learning unit 2 inputs the length measurement target region learning image to a length measurement target region model and learns the length measurement target region model (step S3).

Next, the first model learning unit 2 determines whether learning of the length measurement target region model has ended (step S4). The processing of steps S1 to S4 is repeated until step S4 becomes YES. In step S4, for example, when a loss function of the length measurement target region model becomes a predetermined value or less, it is determined that the processing has ended. Alternatively, when the number of repetitions of steps S1 to S4 reaches a predetermined number, it may be determined that the processing has ended.

In parallel with the processing of steps S1 to S4, the processing of steps S5 to S8 is performed. In step S5, the second learning image generation unit 10 extracts the length measurement target region from the learning image and removes noise in the length measurement target area.

In step S6, the second learning image generation unit 10 adds an attention region and a non-attention region to the length measurement target region from which noise has been removed and generates an attention region learning image and an attention region label image (second label image). The attention region label image is an image for identifying the attention region and the non-attention area. The attention region is, for example, a characteristic shape such as a contour or a part included in the length measurement target area. The non-attention region is, for example, noise such as dust included in the attention area. Various noises are randomly added to the non-attention area. Here, the noise is a foreign substance that is not originally expected to be included in the length measurement target area.

In step S7, the second model learning unit 3 inputs the attention region learning image to the attention region model and learns the attention region model.

In step S8, the second model learning unit 3 determines whether the learning of the attention region model has ended. The processing of steps S5 to S8 is repeated until step S8 becomes YES. The determination in step S8 may be performed based on the same criteria as the determination in step S4.

When YES is determined in steps S4 and S8, the length measurement target region detection unit 4 inputs a detection target image included in the SEM image group to the learned length measurement target region model and detects the length measurement target region inferred by the length measurement target region model (step S9).

Next, the attention region detection unit 5 inputs an image of the detected length measurement target region (length measurement target region image) to the learned attention region model, and detects the attention region inferred by the attention region model (step S10).

Next, the length measurement unit 6 performs length measurement of the length measurement target region based on the attention region detected in step S10 (step S11).

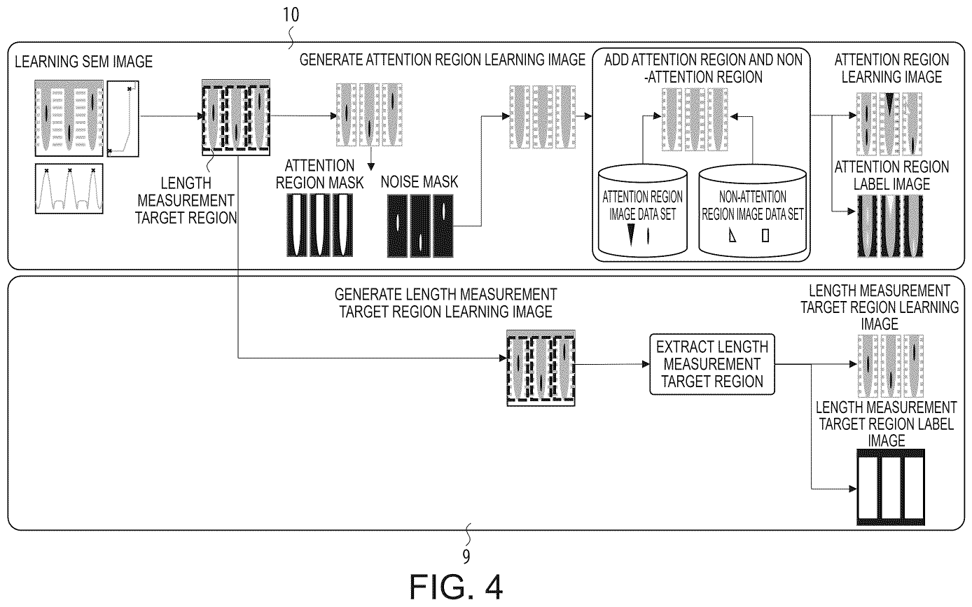

FIG. 4 is a diagram for explaining processing operations of the first learning image generation unit 9 and the second learning image generation unit 10 in FIG. 1 in detail. The first learning image generation unit 9 and the second learning image generation unit 10 perform image processing on the learning image and specify the length measurement target area. FIG. 4 illustrates an example in which a length measurement target region is specified by a line connecting “X” and “X”, and a length measurement target region indicated by a broken line is generated. The first learning image generation unit 9 generates a length measurement target region image and a length measurement target region label image indicating a location of the length measurement target region based on the length measurement target area.

The second learning image generation unit 10 generates an attention region mask and a noise mask for the length measurement target region by image processing or manually. The attention region mask is used to specify the location of the attention region when the attention region label image is generated. A black portion in FIG. 4 indicates the attention area. The noise mask is processing of masking noise in the length measurement target area. A white portion in FIG. 4 represents noise.

Next, the second learning image generation unit 10 performs “inpainting” processing of extracting only a contour of the length measurement target area. In the inpainting processing, the noise mask is used, and the attention region mask is not used. Noise included in the length measurement target region is removed by the inpainting processing. An image after the inpainting processing does not include noise and includes a length measurement target region and an attention area.

Next, the second learning image generation unit 10 generates a plurality of attention region learning images by adding an image of the attention region and an image of the non-attention region to the image after the inpainting processing. The image of the attention region is selected from, for example, various parts included in an attention region image data set. The image of the non-attention region is selected from, for example, various noises included in a non-attention region image data set. The attention region image data set and the non-attention region image data set are prepared in advance based on the learning image data set. Furthermore, as will be described later, parts and noise included in the attention region image data set and the non-attention region image data set may be arbitrarily added.

The second learning image generation unit 10 generates the attention region learning image and generates the attention region label image indicating the positions of the image of the attention region and the image of the non-attention area.

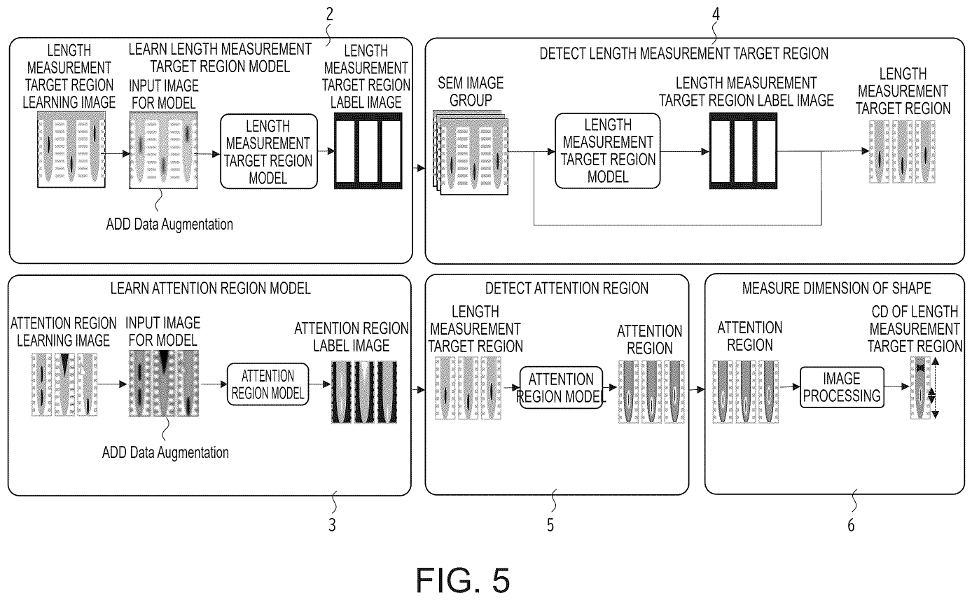

FIG. 5 is a diagram for explaining the processing operations of the first model learning unit 2, the second model learning unit 3, the length measurement target region detection unit 4, the attention region detection unit 5, and the length measurement unit 6 in FIG. 1 in detail.

The first model learning unit 2 adds data augmentation such as blurring to the length measurement target region image generated by the first learning image generation unit 9 and generates an input image for the length measurement target region model. The first model learning unit 2 performs learning of the length measurement target region model so that the length measurement target region model outputs a correct length measurement target region label image.

The second model learning unit 3 adds data augmentation such as blurring to the attention region image generated by the second learning image generation unit 10 and generates an input image for the attention region model. The second model learning unit 3 performs learning of the attention region model so that the attention region model outputs a correct attention region label image.

The length measurement target region detection unit 4 inputs a detection target image selected from the SEM image group to the learned length measurement target region model, and detects a length measurement target region (more precisely, the length measurement target region image) by image processing based on the length measurement target region label image inferred by the length measurement target region model and the detection target image.

The attention region detection unit 5 inputs the length measurement target region image detected by the length measurement target region detection unit 4 to the learned attention region model and detects the inferred attention region (more precisely, the attention region image).

The length measurement unit 6 performs length measurement of the attention region included in the length measurement target region by performing image processing on the attention region image detected by the attention region detection unit 5.

As described above, in the first embodiment, the length measurement target region learning image and the attention region learning image are generated from the learning image, the length measurement target region model and the attention region model are learned using these learning images, the detection target image is input to the learned length measurement target region model and inference is performed to detect the length measurement target region image, and the detected length measurement target region image is input to the learned attention region model and inference is performed to detect the attention region image. As a result, the length measurement of the length measurement target region can be performed with high accuracy using a small number of learning images. In addition, since the learning of the attention region model is performed by using the attention region learning image intentionally including various noises, it is possible to perform length measurement of the length measurement target region without being affected by noise even when noise is included in the detection target image, and noise resistance is increased.

### Second Embodiment

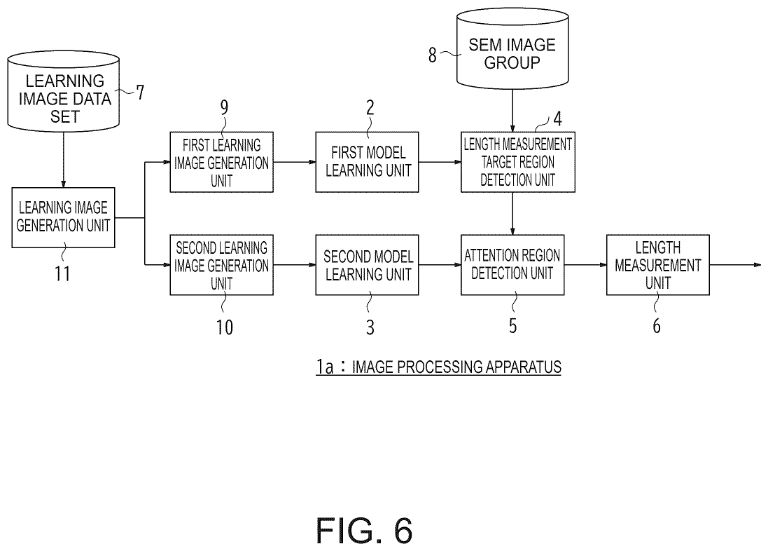

FIG. 6 is a block diagram illustrating a schematic configuration of an image processing apparatus 1a according to a second embodiment. The image processing apparatus 1a according to the second embodiment illustrated in FIG. 6 includes a learning image generation unit 11 in addition to the block configuration of FIG. 1.

The learning image generation unit 11 generates a plurality of learning images to be used by the first learning image generation unit 9 and the second learning image generation unit 10.

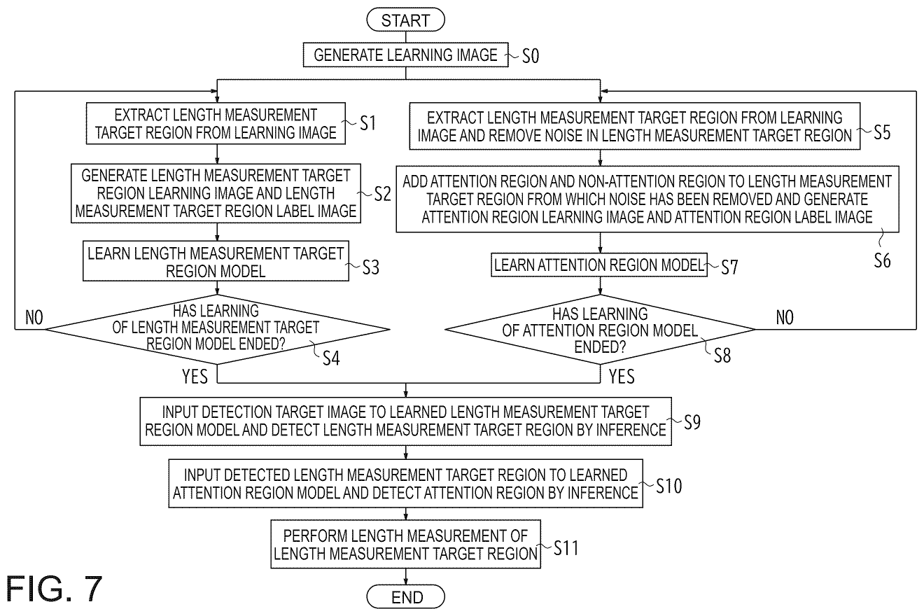

FIG. 7 is a flowchart illustrating a processing operation of the image processing apparatus 1a according to the second embodiment. In the flowchart of FIG. 7, step S0 is added before step S1 of the flowchart of FIG. 2. Step S1 and subsequent steps in FIG. 7 are similar to those in the flowchart in FIG. 2.

In step S0, the learning image generation unit 11 generates a plurality of learning images to be used by the first learning image generation unit 9 and the second learning image generation unit 10, for example, by using the learning image included in the learning image data set and the detection target image included in the SEM image group.

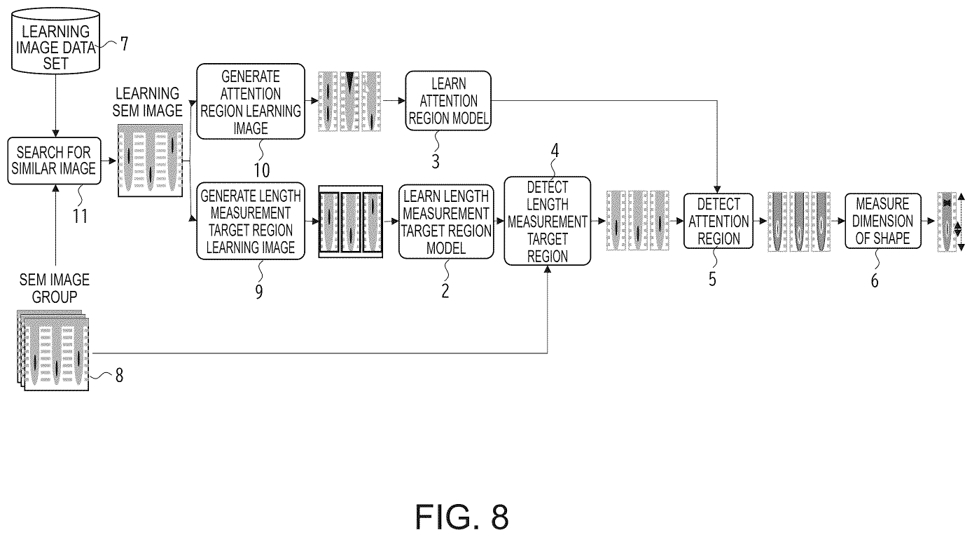

FIG. 8 is a diagram for explaining a processing operation of the learning image generation unit 11 in FIG. 7. As illustrated in FIG. 8, the learning image generation unit 11 performs similar image search by using the learning image included in the learning image data set and the detection target image included in the SEM image group to generate a learning SEM image (hereinafter, simply referred to as a learning image). The learning image generated by the learning image generation unit 11 is supplied to the first learning image generation unit 9 and the second learning image generation unit 10.

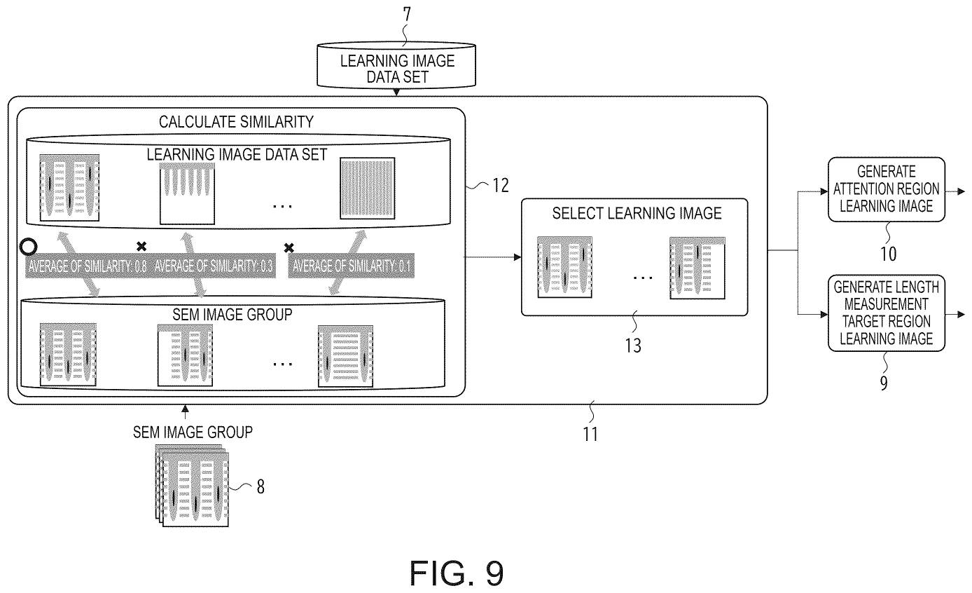

FIG. 9 is a diagram for explaining the processing operation of the similar image search performed by the learning image generation unit 11 in FIG. 7 in detail. The learning image generation unit 11 includes a similarity calculation unit 12 and an image selection unit 13.

The similarity calculation unit 12 calculates similarity between the plurality of learning images included in the learning image data set and the plurality of detection target images included in the SEM image group. For example, the similarity calculation unit 12 calculates cosine similarity of an average feature amount of all the detection target images with respect to feature amounts of respective learning images. Alternatively, the similarity calculation unit 12 may calculate an average value of cosine similarity of feature amounts of the respective detection target images with respect to feature amounts of the respective learning images.

The image selection unit 13 selects, for example, a learning image having similarity of a predetermined value or more from among a plurality of similarities calculated by the similarity calculation unit 12. The predetermined value is arbitrary. As a specific example, the image selection unit 13 selects a learning image whose similarity is included in the top 50%.

As described above, in the second embodiment, a learning image having high similarity to the detection target image included in the SEM image group is selected from the learning image data set and supplied to the first learning image generation unit 9 and the second learning image generation unit 10. As a result, the first learning image generation unit 9 and the second learning image generation unit 10 can generate a length measurement target region learning image and an attention region learning image suitable for the detection target image. Therefore, the inference accuracy of the length measurement target region inferred by the learned length measurement target region model can be improved.

### Third Embodiment

An image processing apparatus 1a according to a third embodiment has a block configuration similar to that of FIG. 6, and the processing operation of the learning image generation unit 11 is different from that of the second embodiment.

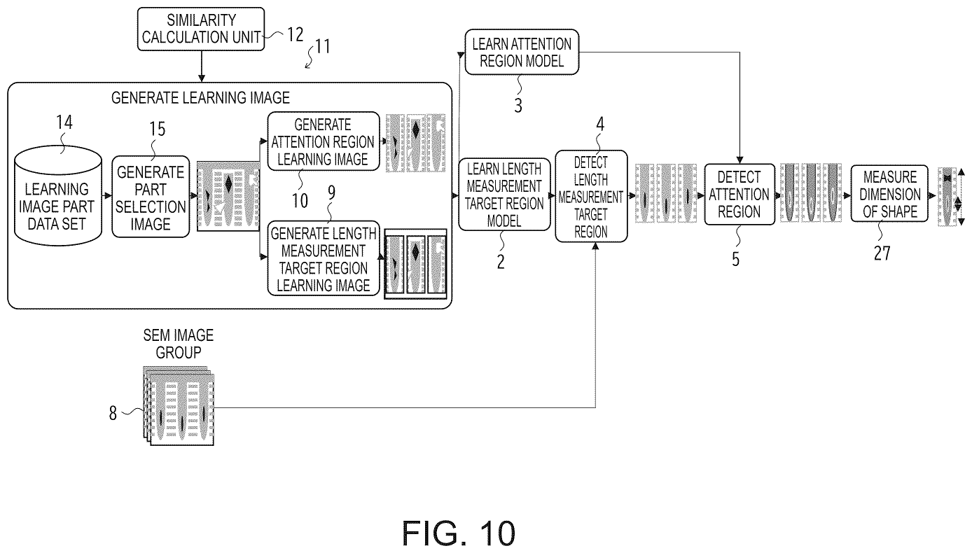

FIG. 10 is a diagram for explaining a processing operation of the learning image generation unit 11 according to the third embodiment. As illustrated in FIG. 10, the learning image generation unit 11 according to the third embodiment includes a similarity calculation unit 12, a part storage unit 14 that stores a learning image part data set, and a part selection image generation unit 15.

The processing of the similarity calculation unit 12 in FIG. 10 is similar to that of the similarity calculation unit 12 in FIG. 9. The part storage unit 14 stores parts included in each of the plurality of learning images included in the learning image data set. The part selection image generation unit 15 randomly selects some parts from a plurality of parts associated with a learning image having high similarity (hereinafter, may be referred to as a representative image).

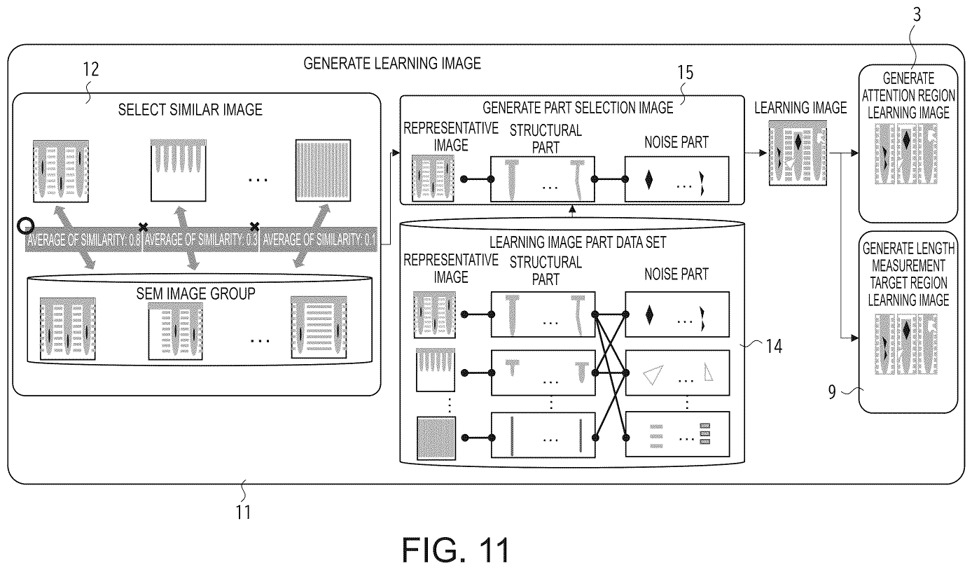

FIG. 11 is a diagram for explaining a processing operation of the learning image generation unit 11 according to the third embodiment in detail. As illustrated in FIG. 11, the part storage unit 14 stores a structural part and a noise part for each learning image (representative image) included in the learning image data set. The structural part is a structure having a characteristic shape of the learning image. The noise part is noise such as dust included in the learning image. The noise part is a part that is not originally expected to be included in the learning image.

The part selection image generation unit 15 generates a learning image by using the learning image having high similarity calculated by the similarity calculation unit 12 as a representative image and randomly adding a structural part and a noise part associated with the representative image. The generated learning image is supplied to the first learning image generation unit 9 and the second learning image generation unit 10.

As described above, in the third embodiment, since the learning image is generated by randomly adding the structural part and the noise part of the learning image having high similarity with the detection target image, a necessary and sufficient number of learning images can be easily generated without preparing many learning images in advance. In particular, in the third embodiment, the noise parts can be arbitrarily combined for each shape of the learning image, and the learning image can be diversified.

### Fourth Embodiment

An image processing apparatus 1a according to a fourth embodiment has a block configuration similar to that of FIG. 6, and a processing operation of the learning image generation unit 11 is different from those of the second and third embodiments.

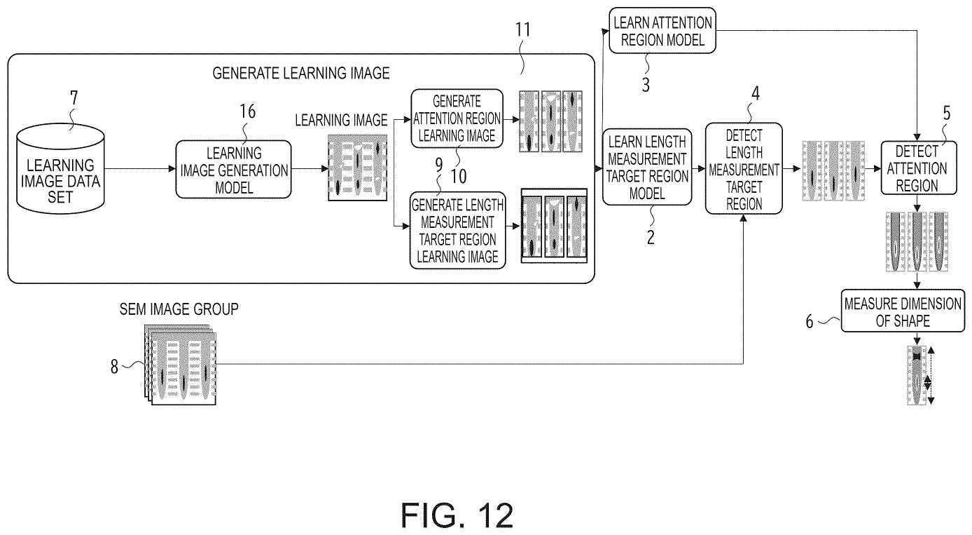

FIG. 12 is a diagram for explaining a processing operation of the learning image generation unit 11 according to the fourth embodiment. As illustrated in FIG. 12, the learning image generation unit 11 according to the fourth embodiment generates a learning image by using a learning image generation model 16. For example, a multimodal model is used as the learning image generation model 16. The multimodal model is a model that can perform inference processing by using a plurality of types of input data and parameters.

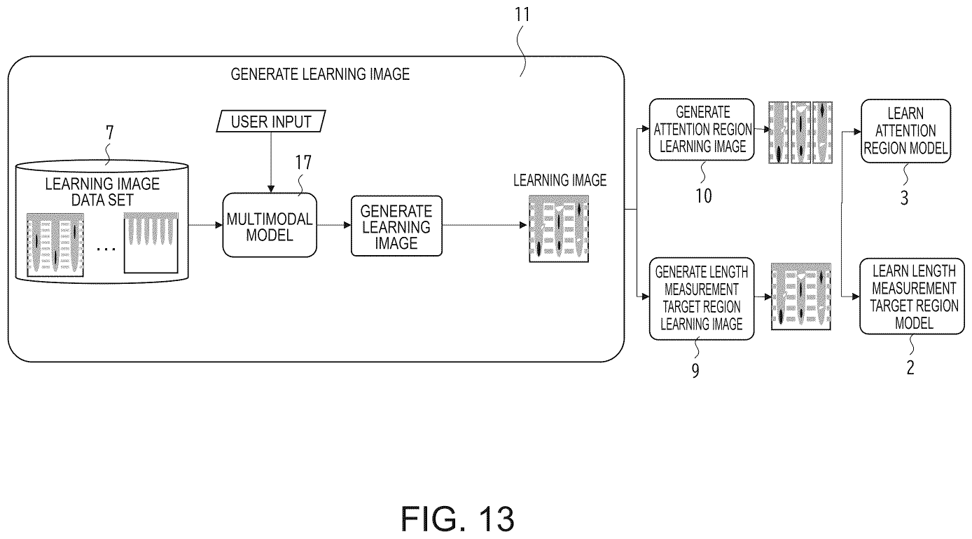

FIG. 13 is a diagram for explaining the processing operation of the learning image generation unit 11 according to the fourth embodiment in detail. The learning image generation unit 11 uses a learned multimodal model 17. The multimodal model 17 inputs a plurality of types of data and parameters, performs inference processing, and outputs an image subjected to the inference processing. User instruction information includes, for example, information for designating at least one of an attention region and noise. The noise includes, for example, structural defects or holes containing dust.

The learning image inferred by the multimodal model 17 is an image obtained by adding at least one of a new attention region and noise to the original learning image.

In addition, the detection target image may be given to the multimodal model 17 as an input parameter. As a result, it is possible to generate a learning image having high similarity with the detection target image.

The learning image inferred by the multimodal model 17 is supplied to the first learning image generation unit 9 and the second learning image generation unit 10.

As described above, in the fourth embodiment, since the learning image is generated by using the learned multimodal model 17, it is possible to simply generate a large number of learning images suitable for the detection target image by performing learning of the multimodal model 17 in advance.

### Fifth Embodiment

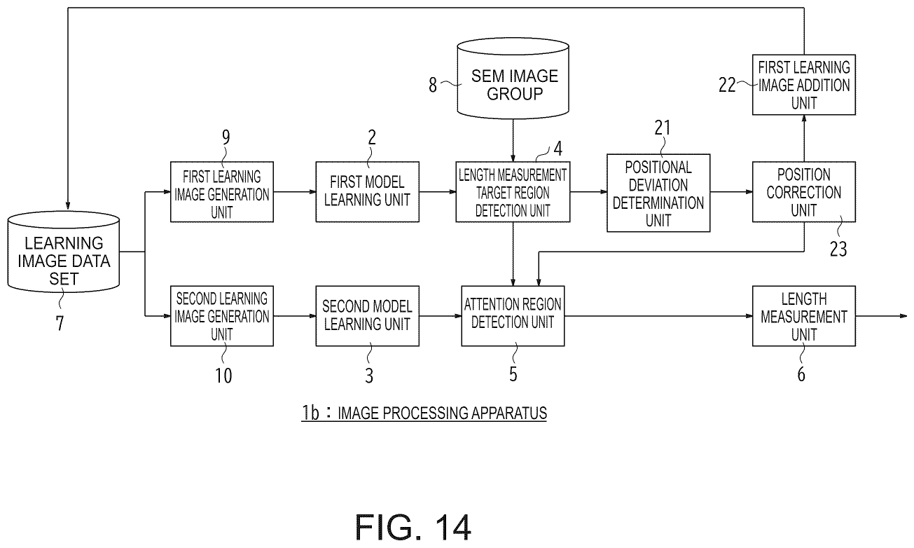

FIG. 14 is a block diagram illustrating a schematic configuration of an image processing apparatus 1b according to a fifth embodiment. The image processing apparatus 1b according to the fifth embodiment illustrated in FIG. 14 includes a positional deviation determination unit 21 and a first learning image addition unit 22 in addition to the block configuration of FIG. 1.

The positional deviation determination unit 21 inputs a detection target image to the learned length measurement target region model and determines whether a position of a length measurement target region inferred by the length measurement target region model is in a normal range.

The first learning image addition unit 22 adds the detection target image including the length measurement target region determined to be in the normal range by the positional deviation determination unit 21 to the learning image data set as a new learning image.

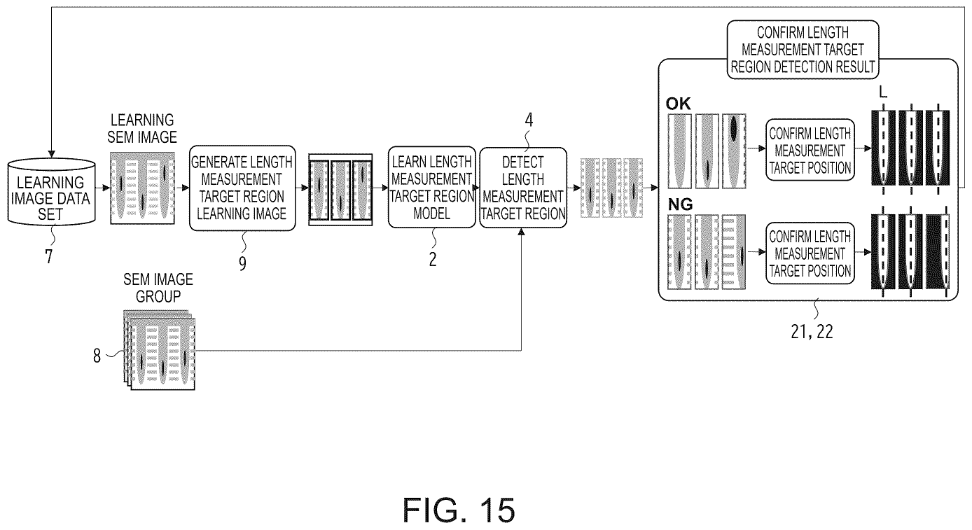

FIG. 15 is a diagram for explaining processing operations of the positional deviation determination unit 21 and the first learning image addition unit 22 according to the fifth embodiment. The positional deviation determination unit 21 confirms the position of the length measurement target region detected by the length measurement target region detection unit 4, and determines whether the position of the length measurement target region is in a normal range. A broken line L in FIG. 15 indicates a center line of the length measurement target area. For example, the positional deviation determination unit 21 determines whether the center line is positioned in the normal range.

The first learning image addition unit 22 adds the detection target image having the length measurement target region determined to be positioned in the normal range to the learning image data set.

The image processing apparatus 1b according to the fifth embodiment illustrated in FIG. 14 may include a position correction unit 23. The position correction unit 23 corrects a length measurement target position when the positional deviation determination unit 21 determines that the position is not in the normal range. In this case, the first learning image addition unit 22 adds the detection target image including the length measurement target region after the correction of the length measurement target position by the position correction unit 23 to the learning image data set as a new learning image. In addition, the detection target image before correction may be deleted from the SEM image group.

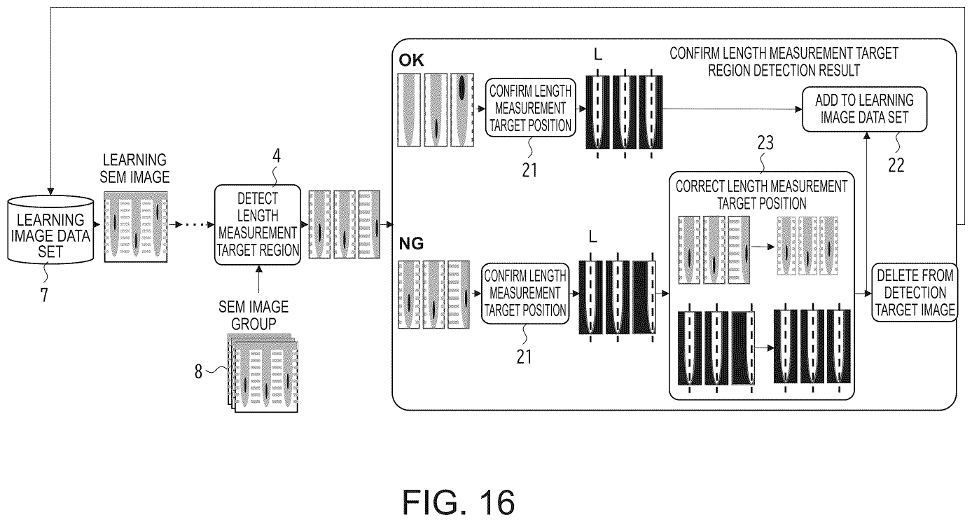

FIG. 16 is a diagram in which the position correction unit 23 is added to FIG. 15. The position correction unit 23 shifts the position of the length measurement target region so that the position of the length measurement target region falls in the normal range.

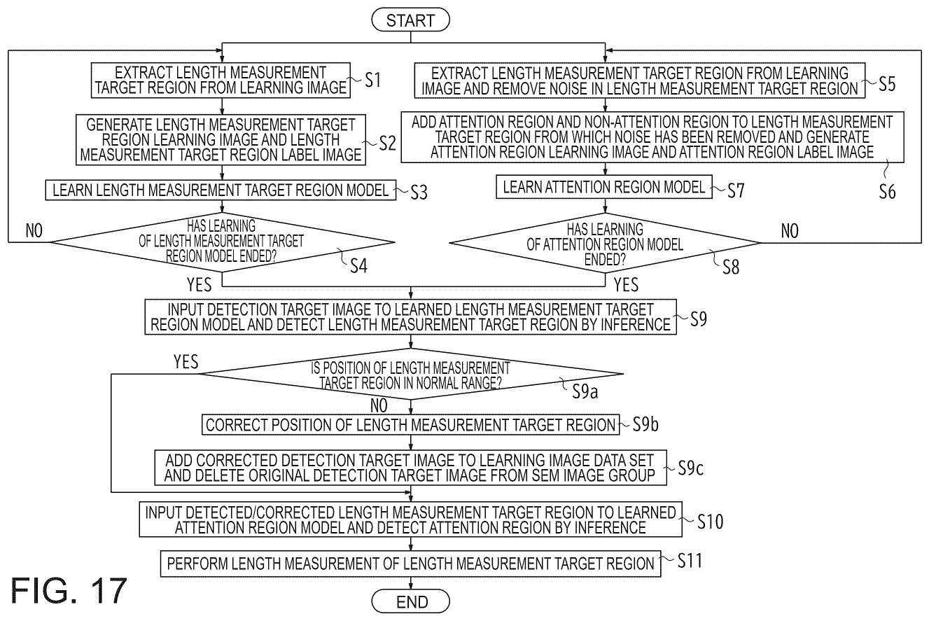

FIG. 17 is a flowchart illustrating a processing operation of the image processing apparatus 1b according to the fifth embodiment. The flowchart of FIG. 17 includes a processing operation by the position correction unit 23. The flowchart of FIG. 17 is obtained by adding processing of steps S9a and S9b between steps S9 and S10 of FIG. 2.

In step S9a, the positional deviation determination unit 21 confirms a position of the length measurement target region detected by the length measurement target region detection unit 4, and determines whether the position of the length measurement target region is in a normal range.

In step S9b, when it is determined in step S9a that the position of the length measurement target region is out of the normal range, the position correction unit 23 corrects the position of the length measurement target region to fall in the normal range. In a case where it is determined in step S9a that the position of the length measurement target region is in the normal range, processing in step S10 described later is performed.

In step S9c, the detection target image corresponding to the corrected length measurement target region is added to the learning image data set, and the original detection target image is deleted from the SEM image group.

In step S10, the image of the detected or corrected length measurement target region is input to the learned attention region model, and the attention region is detected by inference. Thereafter, length measurement of the length measurement target region is performed (step S11).

As described above, in the fifth embodiment, it is determined whether the position of the length measurement target region is in the normal range, and the detection target image including the length measurement target region determined to be in the normal range is added to the learning image data set, thereby efficiently increasing the number of learning images. In addition, when it is determined that the position of the length measurement target region is out of the normal range, the position of the length measurement target region is corrected and then added to the learning image data set, so that the length measurement of the length measurement target region can be accurately performed.

### Sixth Embodiment

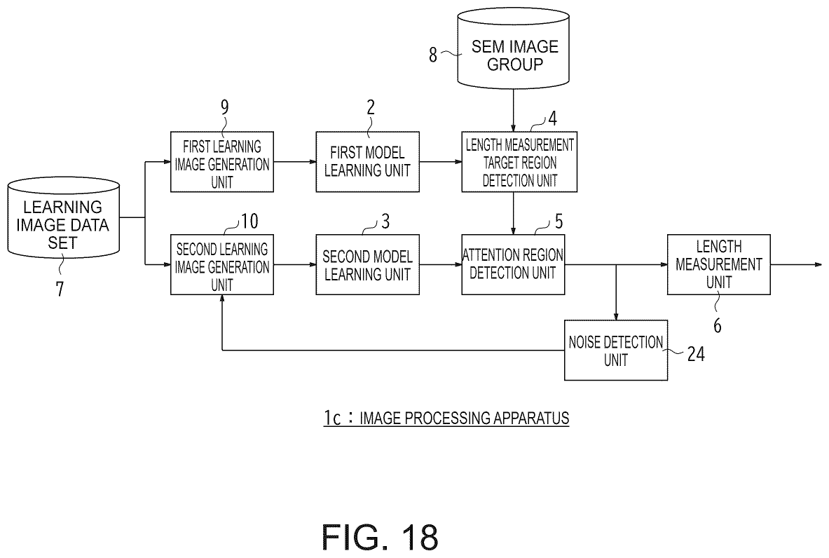

FIG. 18 is a block diagram illustrating a schematic configuration of an image processing apparatus 1c according to a sixth embodiment. The image processing apparatus 1c according to the sixth embodiment illustrated in FIG. 18 includes a noise detection unit 24 in addition to the block configuration of FIG. 1.

The noise detection unit 24 inputs the length measurement target region to the learned attention region model and detects noise included in the attention region inferred by the attention region model. The noise is, for example, a foreign substance that does not originally exist in the attention area, such as dust.

The second learning image generation unit 10 generates an attention region learning image and a second label image by including the noise detected by the noise detection unit 24 in a non-attention area.

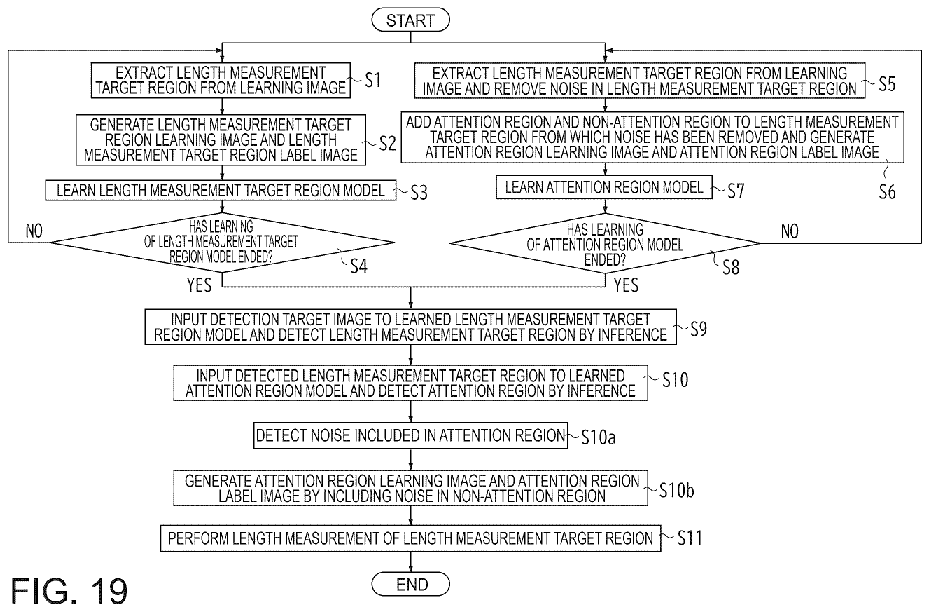

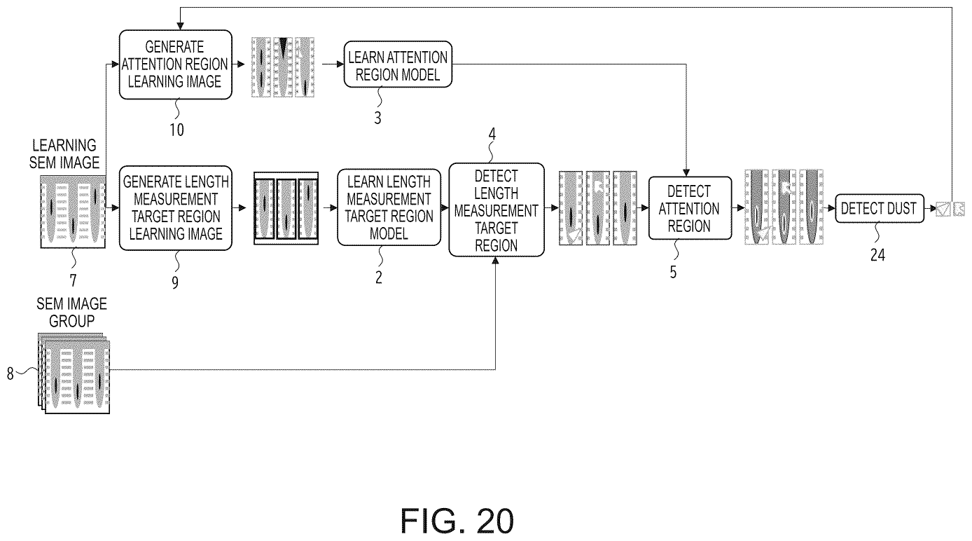

FIG. 19 is a flowchart illustrating a processing operation of the image processing apparatus 1c according to the sixth embodiment, and FIG. 20 is a diagram for explaining a processing operation of the noise detection unit 24 according to the sixth embodiment.

The flowchart of FIG. 19 is obtained by adding steps S10a and S10b between steps S10 and S11 of the flowchart of FIG. 2.

In step S10a, the noise detection unit 24 detects noise included in the attention area. In step S10b, the second learning image generation unit 10 generates the attention region learning image and the second label image by including the noise (for example, dust) detected in step S10a in the non-attention area. The processing of steps S10a and S10b can be performed in parallel with the processing of step S11.

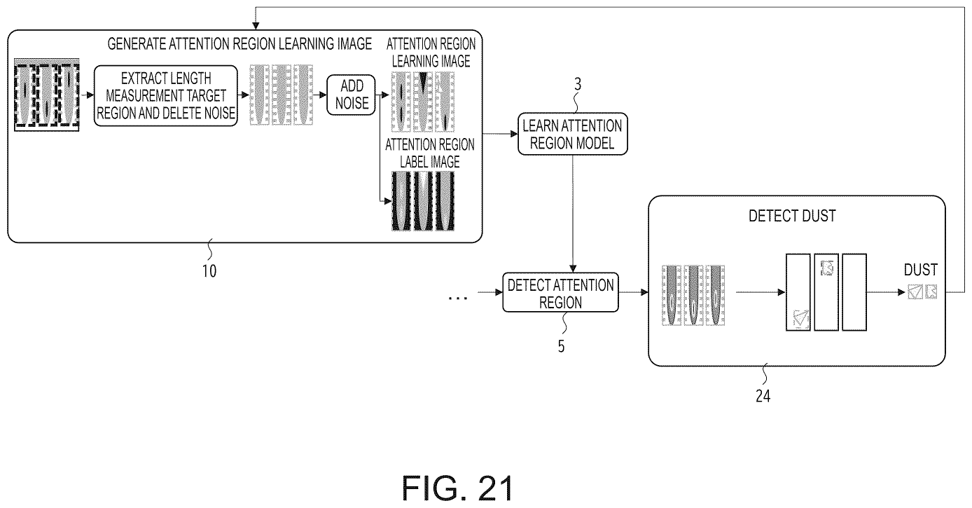

FIG. 21 is a diagram for explaining processing operations of the noise detection unit 24 and the second learning image generation unit 10 in more detail. The noise detection unit 24 detects various noises (for example, dust) included in the attention region and cuts out only dust.

The second learning image generation unit 10 generates the attention region learning image by including the dust cut out by the noise detection unit 24 in the non-attention area.

As described above, in the sixth embodiment, since the noise such as dust included in the attention region is detected and the detected noise is included in the non-attention region to generate the attention region learning image, it is possible to extract the noise included in the detection target image and generate a new attention region learning image. Therefore, the attention region learning image can be diversified, and the length measurement of the length measurement target region can be accurately performed even when the detection target image includes noise.

### Seventh Embodiment

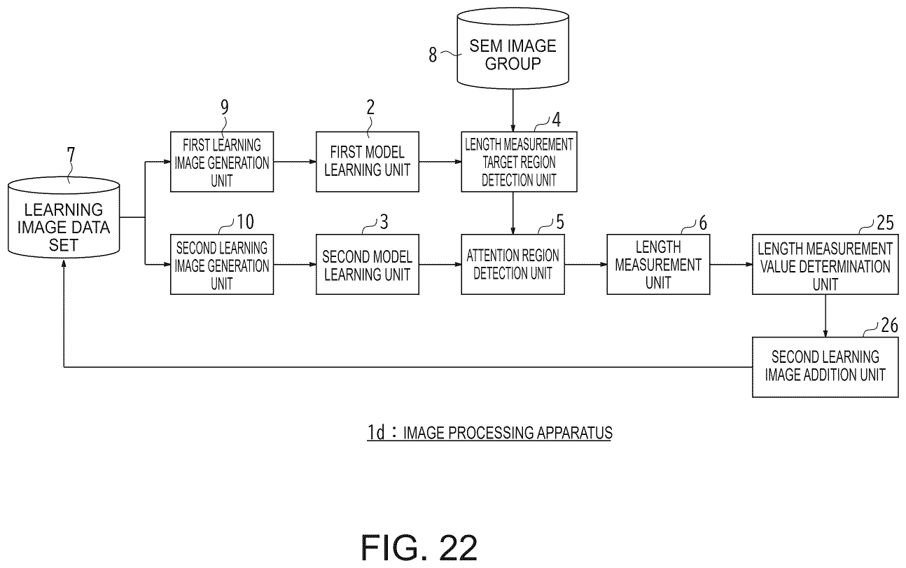

FIG. 22 is a block diagram illustrating a schematic configuration of an image processing apparatus 1d according to a seventh embodiment. The image processing apparatus 1d according to the seventh embodiment illustrated in FIG. 22 includes a length measurement value determination unit 25 and a second learning image addition unit 26 in addition to the block configuration of FIG. 1.

The length measurement value determination unit 25 determines whether a length measurement value of the length measurement target region measured by the length measurement unit 6 falls within an allowable range. The allowable range is determined in consideration of, for example, past length measurement results.

The second learning image addition unit 26 adds the detection target image including the length measurement target region determined to fall within the allowable range by the length measurement value determination unit 25 to the learning image data set as a new learning image.

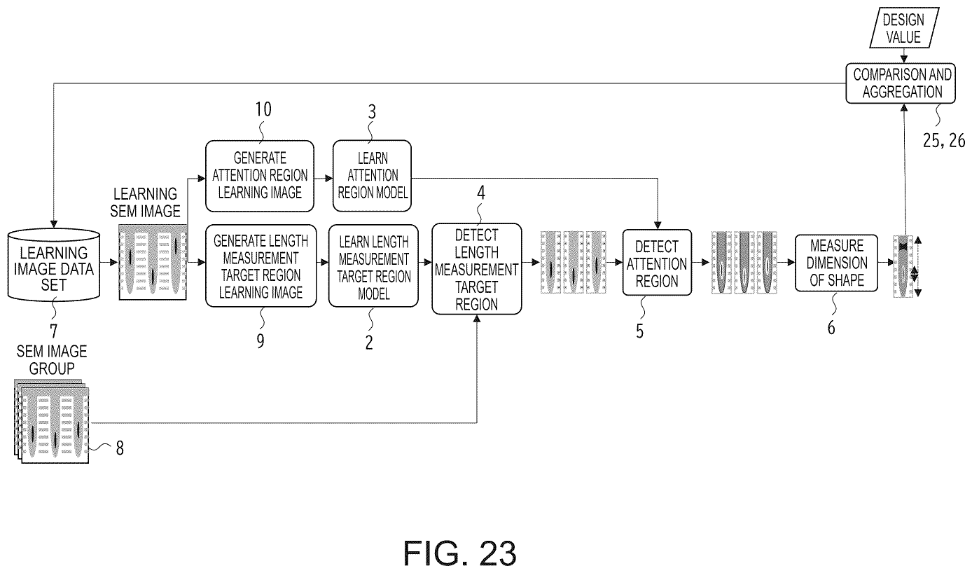

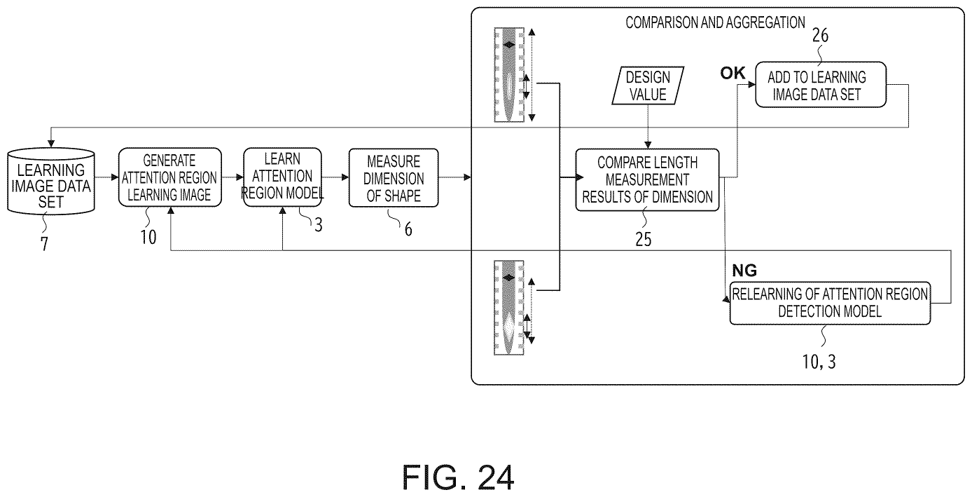

FIG. 23 is a diagram for explaining processing operations of the length measurement value determination unit 25 and the second learning image addition unit 26 according to the seventh embodiment. FIG. 24 is a diagram for explaining the processing operations of the length measurement value determination unit 25 and the second learning image addition unit 26 according to the seventh embodiment in more detail.

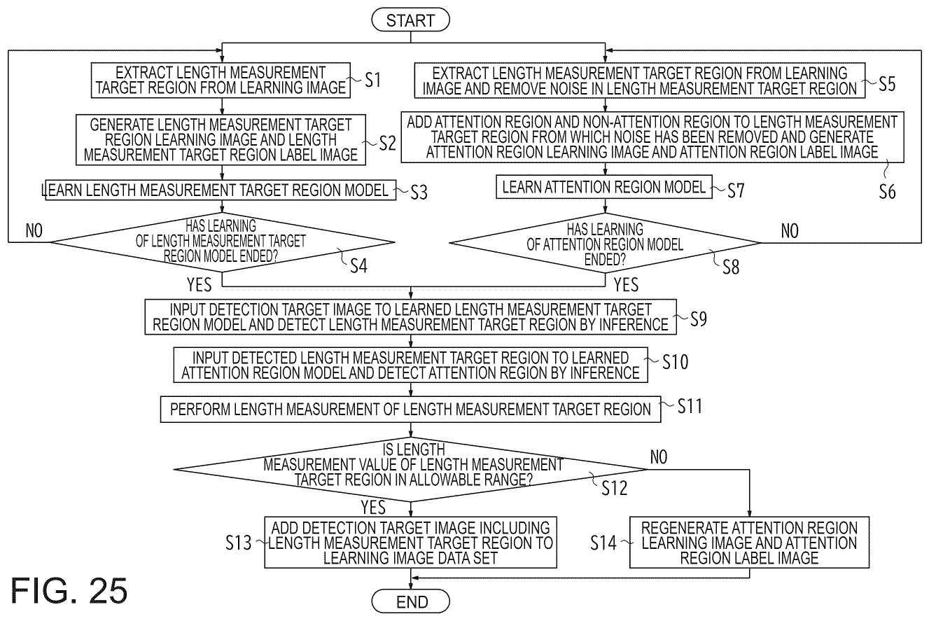

FIG. 25 is a flowchart illustrating a processing operation of the image processing apparatus 1d according to the seventh embodiment. The flowchart of FIG. 25 is obtained by adding steps S12 to S14 after step S11 of the flowchart of FIG. 2.

In step S12, the length measurement value determination unit 25 compares the length measurement value of the length measurement target region measured by the length measurement unit 6 with a design value to determine whether the length measurement value falls within the allowable range.

In step S13, when the determination in step S12 is YES, the detection target image including the length measurement target region is added to the learning image data set.

In step S14, when the determination in step S12 is NO, the second learning image generation unit 10 regenerates the attention region learning image and the label image to be used for learning the attention region model. Thereafter, the processing of step S8 and subsequent steps is performed.

As described above, in the seventh embodiment, when the length measurement value of the length measurement target region measured by the length measurement unit 6 falls within the allowable range, the detection target image including the length measurement target region is added to the learning image data set, thereby easily increasing the number of learning images. In addition, when the length measurement value of the length measurement target region is out of the allowable range, the attention region learning image is regenerated, so that reliability of the length measurement value of the length measurement target region can be improved.

### Eighth Embodiment

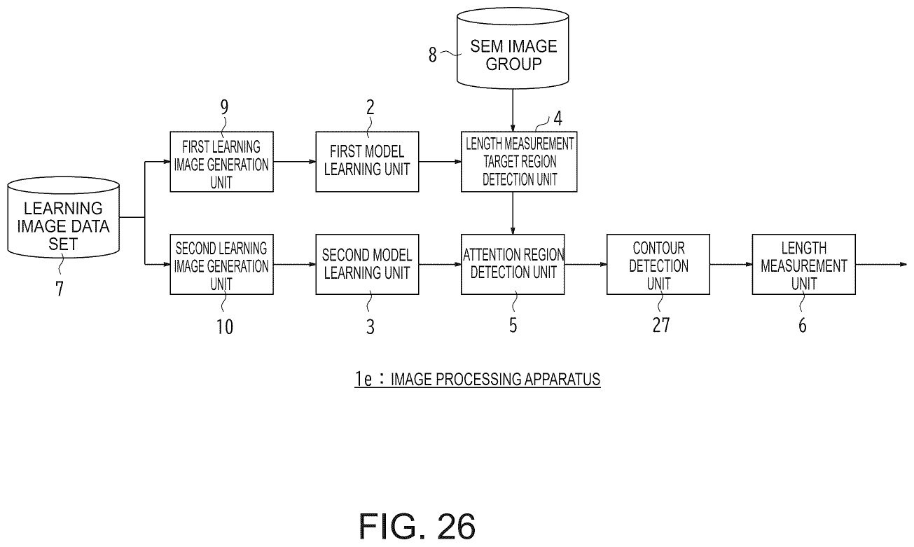

FIG. 26 is a block diagram illustrating a schematic configuration of an image processing apparatus 1e according to an eighth embodiment. The image processing apparatus 1e according to the eighth embodiment illustrated in FIG. 26 includes a contour detection unit 27 in addition to the block configuration of FIG. 1.

The contour detection unit 27 detects a contour of the length measurement target area. Note that the contour includes a shape of the length measurement target area. The length measurement unit 6 performs length measurement of the length measurement target region based on the contour of the length measurement target region detected by the contour detection unit 27.

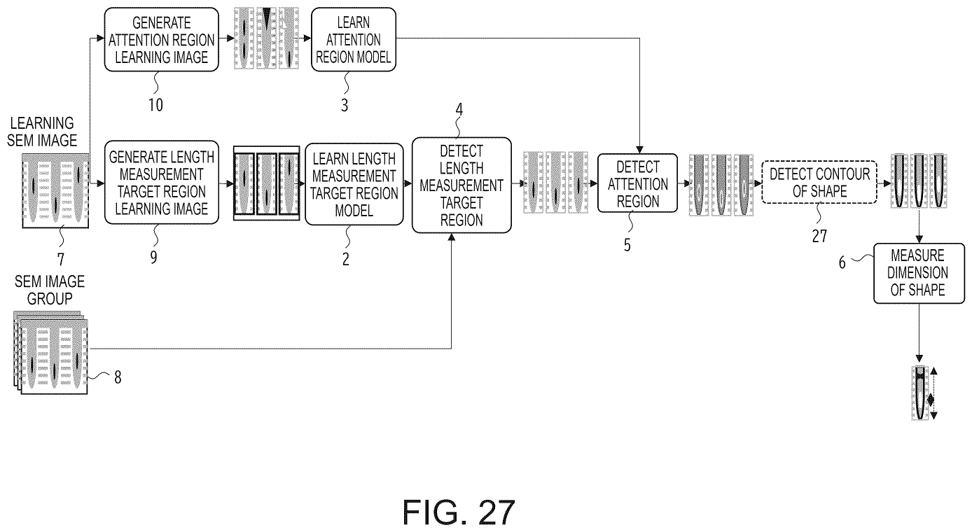

FIG. 27 is a diagram for explaining a processing operation of the contour detection unit 27 in FIG. 26. Since the contour detection unit 27 detects the contour of the length measurement target region and then the length measurement unit 6 performs length measurement, the length measurement unit 6 can easily perform the length measurement.

At least some of the image processing apparatuses 1 to 1e described in the above-described embodiments may be configured by hardware or software. In a case where at least some of the image processing apparatuses 1 to 1e is configured by software, a program for realizing at least some functions of the image processing apparatuses 1 to 1e may be stored in a recording medium such as a flexible disk or a CD-ROM, and may be read and executed by a computer. The recording medium is not limited to a removable recording medium such as a magnetic disk or an optical disk, and may be a fixed recording medium such as a hard disk device or a memory.

In addition, the program for realizing at least some functions of the image processing apparatuses 1 to 1e may be distributed via a communication line (including wireless communication) such as the Internet. Further, the program may be distributed via a wired line or a wireless line such as the Internet or stored in a recording medium in an encrypted, modulated, or compressed state.

While certain embodiments have been described, these embodiments have been presented by way of example only, and are not intended to limit the scope of the disclosures. Indeed, the novel methods and systems described herein may be embodied in a variety of other forms; furthermore, various omissions, substitutions and changes in the form of the methods and systems described herein may be made without departing from the spirit of the disclosures. The accompanying claims and their equivalents are intended to cover such forms or modifications as would fall within the scope and spirit of the disclosures.

1. An image processing apparatus comprising processing circuitry configured to:
perform learning of a first model for detecting a length measurement target region included in a learning image;
perform learning of a second model for detecting an attention region included in the learning image;
input a detection target image to the learned first model and detect a length measurement target region inferred by the first model;
input an image of the detected length measurement target region to the learned second model and detect an attention region inferred by the second model; and
perform length measurement of the length measurement target region based on the detected attention region.

2. The image processing apparatus according to claim 1, wherein
the attention region includes at least one of a contour of the length measurement target region, a shape of the length measurement target region, or a part included in the length measurement target region.

3. The image processing apparatus according to claim 1, wherein the processing circuitry is further configured to:
generate a length measurement target region learning image to be used for learning the first model based on the learning image; and
generate an attention region learning image to be used for learning the second model based on the learning image, wherein
the processing circuitry is configured to:
perform learning of the first model for detecting a length measurement target region included in the length measurement target region learning image, and
perform learning of the second model for detecting an attention region included in the attention region learning image.

4. The image processing apparatus according to claim 3, wherein
the processing circuitry is configured to:
extract the length measurement target region from the learning image, and generate the length measurement target region learning image and a first label image for identifying the length measurement target region based on the extracted length measurement target region, and
extract the length measurement target region from the learning image, and after removing noise in the extracted length measurement target region, add an image of an attention region and an image of a non-attention region, and generate the attention region learning image and a second label image indicating the attention region and the non-attention region.

5. The image processing apparatus according to claim 3, wherein the processing circuitry is further configured to generate a plurality of the learning images to be used.

6. The image processing apparatus according to claim 5, wherein
the processing circuitry is configured to select, as the learning image, from a learning image data set including a plurality of learning image candidates, a learning image candidate having similarity of a predetermined value or more to a plurality of the detection target images.

7. The image processing apparatus according to claim 6, wherein
the processing circuitry is configured to select, as the learning image, the learning image candidate in which cosine similarity of an average feature amount of the plurality of detection target images with respect to a feature amount of each of the plurality of learning image candidates, or an average value of the cosine similarity of the feature amount of each of the plurality of detection target images with respect to the feature amount of each of the plurality of learning image candidates is equal to or more than the predetermined value.

8. The image processing apparatus according to claim 5, wherein
the processing circuitry is configured to generate the learning image, from a learning image data set including a plurality of learning image candidates, by randomly adding at least one of a plurality of structural parts and a plurality of noise parts associated with a representative image to the representative image, with the learning image candidate having similarity of a predetermined value or more to the plurality of detection target images as the representative image.

9. The image processing apparatus according to claim 5, wherein
the processing circuitry is configured to input a learning image candidate and user instruction information to a learned multimodal model, and set an output image inferred by the multimodal model as the learning image.

10. The image processing apparatus according to claim 9, wherein
the instruction information includes information for designating at least one of the attention region and noise.

11. The image processing apparatus according to claim 1, wherein the processing circuitry is further configured to:
input the detection target image to the learned first model and determine whether a position of the length measurement target region inferred by the first model is in a normal range; and
add the detection target image including the length measurement target region determined to be in the normal range to a learning image data set as a new learning image.

12. The image processing apparatus according to claim 11, wherein the processing circuitry is further configured to correct a length measurement target position when determined that the position is not in the normal range, wherein
the processing circuitry is configured to add the detection target image including the length measurement target region after correcting the length measurement target position to the learning image data set as the new learning image.

13. The image processing apparatus according to claim 3, wherein the processing circuitry is further configured to input the image of the length measurement target region to the learned second model and detect noise included in the attention region inferred by the second model, wherein
the processing circuitry is configured to generate the attention region learning image by using the detected noise.

14. The image processing apparatus according to claim 1, wherein the processing circuitry is further configured to:
determine whether a length measurement value of the measured length measurement target region falls within an allowable range; and
add the detection target image including the length measurement target region determined to fall within the allowable range to a new learning image.

15. The image processing apparatus according to claim 3, wherein the processing circuitry is further configured to:
determine whether a length measurement value of the measured length measurement target region falls within an allowable range; and
add the detection target image including the length measurement target region determined to fall within the allowable range to a new learning image, wherein
when determined that the length measurement value does not fall within the allowable range, the processing circuitry is configured to regenerate the attention region learning image to be used for learning of the second model.

16. The image processing apparatus according to claim 1, wherein
the learning image and the detection target image are semiconductor images.

17. An image processing method comprising:
performing learning of a first model for detecting a length measurement target region included in a learning image;
performing learning of a second model for detecting an attention region included in the learning image;
inputting a detection target image to the learned first model and detecting a length measurement target region inferred by the first model;
inputting an image of the detected length measurement target region to the learned second model and detecting an attention region inferred by the second model; and
performing length measurement of the length measurement target region based on the detected attention region.

18. The image processing method according to claim 17, wherein
the attention region includes at least one of a contour of the length measurement target region, a shape of the length measurement target region, and a part included in the length measurement target region.

19. The image processing method according to claim 17, further comprising:
generating a length measurement target region learning image to be used for learning the first model based on the learning image;
generating an attention region learning image to be used for learning the second model based on the learning image;
performing learning of the first model for detecting a length measurement target region included in the length measurement target region learning image; and
performing learning of the second model for detecting an attention region included in the attention region learning image.

20. The image processing method according to claim 19, further comprising:
extracting the length measurement target region from the learning image, and generating the length measurement target region learning image and a first label image for identifying the length measurement target region based on the extracted length measurement target region; and
extracting the length measurement target region from the learning image, and after removing noise in the extracted length measurement target region, adding an image of an attention region and an image of a non-attention region, and generating the attention region learning image and a second label image indicating the attention region and the non-attention region.
